(19) United States
(12) Patent Application Publication
(10) Pub. No.: US 2008/0238932 A1
(43) Pub. Date: Oct. 2, 2008

(54) Method and device for adjusting color value for a low-noise visualization of volumetric objects

(76) Inventors: Klaus Engel, Donauworth (DE); Jesko Schwarzer, Bonn (DE)

Correspondence Address: BRINKS HOFER GILSON & LIONE, P.O. BOX 10395, CHICAGO, IL, 60610, US

(21) Appl. No.: 12/077,796

(22) Filed: Mar. 20, 2008

(30) Foreign Application Priority Data
Mar. 27, 2007 (DE) DE102007014 647.9

(51) Int. Cl. G09G 5/02

(52) U.S. Cl. 345/591

(57) ABSTRACT

A device for adjusting a color value assigned to a spatial point for a low-noise volume rendering of an object is provided. The device mixes a first color value from a classification unit with a second color value obtained by the application of an illumination model on the first color value.

The present patent document claims the benefit of the filing date of German Patent Document DE 10 2007 014 647.9, filed Mar. 27, 2007, which is hereby incorporated by reference.

### BACKGROUND

The present embodiments relate to adjusting a color value assigned to a spatial point for a low-noise volume rendering of a body.

Volume rendering may be used for representation or visualization of three-dimensional bodies or objects. The modeling, reconstruction, and visualization of three-dimensional objects has a wide area of application in the fields of medicine (e.g. CT, PET), physics (e.g. electron structure of large molecules), and geophysics (e.g. nature and positioning of earth layers). The object to be examined is irradiated (e.g. by using electromagnetic waves or sound waves) in order to examine its nature. The scattered radiation from the irradiation is detected and properties of the body are ascertained from the detected values. Generally, the result includes a physical variable (e.g. density, tissue type, elasticity, speed), the value of the physical variable being ascertained for the body. A virtual grid is used as a rule. The value of the variable is ascertained at the grid points of the grid. These grid points are usually designated as voxels. The term “voxel” is generally used in relation with the terms “volume” and “pixel.” A voxel relates to the spatial coordinate of a grid point, to which coordinate the value of a variable at that location is assigned. This involves a physical variable that can be represented as a scalar or vector field. The corresponding field value is assigned to the spatial coordinate. The value of the variable or the field can be obtained at any desired object point (e.g. at any desired location point of the examined object) by interpolation of the voxels.

By using volume rendering, a three-dimensional representation of the examined object or body is generated on a two-dimensional representation surface (e.g. a screen) from the voxels. The pixels are generated from the voxels by the volume rendering (frequently with the interim stage of object points being produced from the voxels by interpolation), of which pixels the image of the two-dimensional image display is composed. To visualize three dimensions on a two-dimensional display, an alpha compositing or an alpha separation may be performed. In the case of this standard method, voxels, or volume points formed from voxels, are assigned both color values and also transmittance values (usually designated by the term opacity, which expresses the transmittance or the covering effect of various layers of the body). An object point is usually assigned a color value in the form of a three-tuple, which encodes the proportions of the colors red, green, and blue (the RGB value), and an alpha value, which parameterizes the transmittance.

An illumination model is used for the purposes of assigning a matching color value. The illumination model may take into account light effects (reflections of the light on surfaces of the object as a rule, including the external surface or surfaces of internal layers of the examined object) of a modeled or simulated irradiation of the object for the purposes of visualization.

Illumination models may include, for example, the Phong, Gouraud or Schlick models. The models share the common feature that the angle between the incident light and the surface normal of the reflecting surface is used for the application of the model. The gradient and, from it, the normal vector is determined for the voxels or object points used for the models.

One method of volume rendering includes ray casting, or the simulation of irradiation with light for the purposes of representing or visualizing the body. Elements of a ray casting visualization are described in the following. In ray casting or ray tracing, as it is also called for volume visualization, imaginary rays that come out of the eye of the observer are transmitted through the examined body or the examined object. Along the rays, object points are calculated from the voxels and combined into a two-dimensional image. The following two procedures are carried out, which can also be carried out separately from one another.

Classification: Transmittance values or alpha values are assigned to the values along the rays.

Shading: Color values are assigned to the individual points with the aid of an illumination model.

Color values and transmittance values are put together to form pixels of the two-dimensional image, such that a three-dimensional representation of the examined body is provided.

A calculation of surface normals is required in the case of the application of an illumination model or in the case of shading in the context of volume rendering. The calculation of the gradient frequently has inaccuracies or errors due to the small variation of the body's properties in homogeneous areas of the volume or the examined body, which reinforces the impression of noise in the calculated images, taking into account external light sources.

### SUMMARY & DESCRIPTION

The present embodiments may obviate one or more of the problems inherent in the related art. For example, one embodiment enables volume rendering with low noise.

In one embodiment, color values that have been subjected to an illumination model or shading are mixed with color values for which no shading has yet been carried out. Two color values are provided, which are assigned to the same spatial point in each case. This spatial point can involve, for example, a voxel (i.e. a grid point of a virtual grid laid through the body) or an object point obtained by interpolation of voxels (which represents, for example, a point on a light ray, simulated in the process of a ray casting, transmitted through the body). A spatial point has three spatial coordinates that define the position of that point. The first color value assigned to the spatial point includes a color value that may have been assigned to a quantitative variable characterizing the body in accordance with the value ascertained for that spatial point. The variable may represent, for example, a physical property such as density, transmittance, elasticity or the like. The first color value forms the starting point for the application of an illumination model or for the shading. A second color value is then obtained from the first color value by the application of the illumination model. The second color value may be used for two-dimensional representations of the body in the process of the volume rendering.

For the purposes of suppressing artifacts or noise, an averaged value is formed from the first and second color values, which may be used for the representation of the body. The averaging is effected (determined) in accordance with a weighting function that is dependent on the magnitude of the gradient, which has been ascertained as a measurement of the change in the variable characterizing the body with reference to the spatial point. The weighting function increases from a minimum weighting value for the second color value to a maximum weighting value for the second color value. The minimum weighting value may be 0, and the maximum weighting value 1. The first color value, for which no shading has been carried out, is independent of the gradient. The lower weighting of the second color value for small gradient magnitudes may reduce the influence of the inaccuracies, which result because of a minor variation in the characterizing variable or homogeneousness in the surrounding area of the spatial point. During the volume rendering, a lower-noise image may be generated.

In one embodiment, a form of the weighting function includes a ramp function, which has a low consumption of resources because it is easily calculated.

The present embodiments include a device for volume rendering by using ray casting, which may be configured to adjust a color value assigned to a spatial point by mixing color values.

### BRIEF DESCRIPTION OF THE DRAWINGS

FIG. 1 illustrates a first embodiment of a rendering pipeline for volume rendering by using ray casting;

FIG. 2 illustrates a second embodiment of a rendering pipeline for volume rendering by using ray casting;

FIG. 3 illustrates a third embodiment of a rendering pipeline for volume rendering by using ray casting;

FIG. 4 illustrates an embodiment of a representation of the estimation of the gradient magnitude in the process of ray casting

FIG. 5 illustrates an embodiment of a representation of the mixing unit, which includes a part of the rendering pipeline

FIG. 6 illustrates an example ramp function for mixing color values

### DETAILED DESCRIPTION

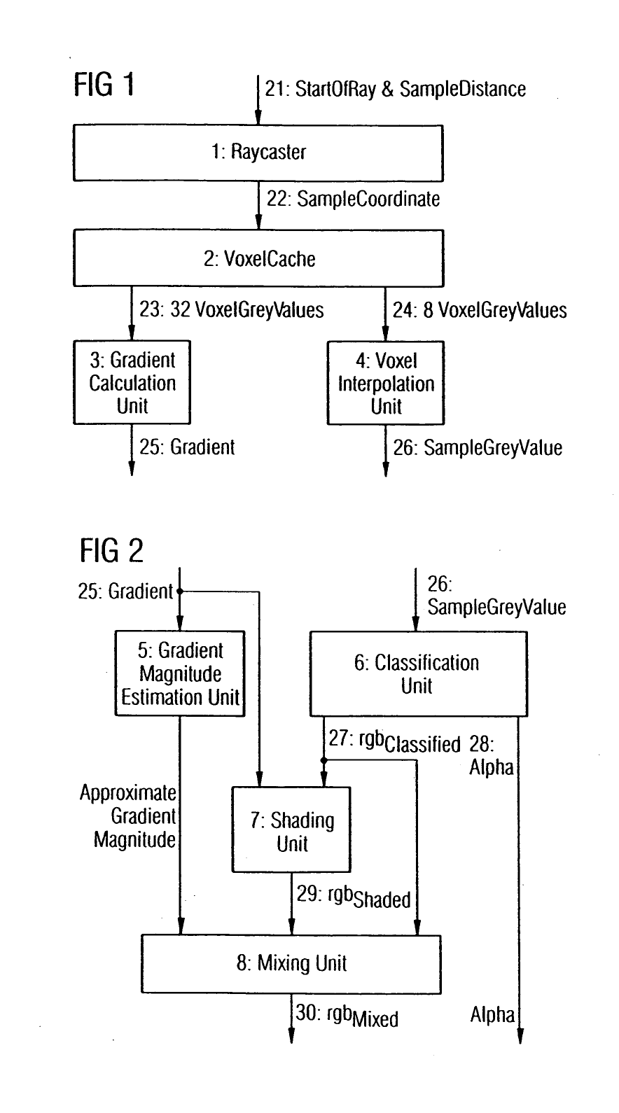

The present embodiments may be used for representation or visualization of three-dimensional bodies or objects in any field. For example, as shown in the FIGS. 1 to 6, the present embodiments may be used during a medical imaging procedure. In the process of the imaging procedure, a human body is to be examined with test radiation. The examination results include a variable characterizing the examined tissue, the density, the value of which has been ascertained for grid points, the voxels. During the volume rendering, these values are used for the visualization of the examined body tissue.

FIGS. 1 to 3 show a rendering pipeline for a ray-casting process. RGBA values (four-tuples including the color value components red, blue, and green, plus the alpha value) are ascertained (determnined) iteratively in equidistant samples along a ray, which corresponds to the direction of view, which values represent a color value (three-tuple including color value components red, blue, and green) and a transmittance value (alpha value) in each case. The color values along a ray may be superimposed to form a pixel of the two-dimensional image by using the alpha values.

In act 21, the direction of the ray and the step size are defined. Then, the ray simulation is started. Act 21 takes place with the aid of a suitable program module, which is expressed by the block 1 (ray caster or ray generation) in FIG. 1. The acts represented in FIGS. 1 to 3 are run through point by point on this simulated ray (depending on the ray casting technique, this can take place in the forward or backward direction relative to the observer).

In one embodiment, as shown in FIG. 1, the coordinates of the point or scanning point are determined (Act 21). The next point in each case, which displays a preset distance with respect to the preceding one (SampleDistance or step size), is ascertained iteratively along the ray. Following the determination of the coordinates of the point (Act 21), the adjacent voxels and their values are ascertained. To ascertain the adjacent voxels and their values, the memory containing the voxels and the corresponding density values may be accessed (e.g., read). This is illustrated by block 2 (VoxelCache) in FIG. 1. The density values may include grayscale values (GreyValues). The thirty two (32) voxels and corresponding gray values adjacent to the examined point are used for ascertaining the gradient at this location using a module or a corresponding unit (Block 3: Gradient Calculation Unit) (Act 23). The eight (8) adjacent voxels are used for calculating the gray value at the point under consideration using an interpolation unit (Block 4: Voxel Interpolation Unit) (Act 24). As shown in FIG. 2, the gradient is calculated and made available for calculating the magnitude of the gradient (Block 5: Gradient Magnitude Estimation Unit) and within a shading unit (Block 7: Shading Unit) for the shading or the application of an illumination model (Act 25). The interpolated gray value (SampleGreyValue) is input into a classification unit (Block 6: Classification Unit) (Act 26), in which a first color value (rgb_{Classified}) and an alpha value (Alpha) are allocated to the point (Acts 27 and 28).

The allocation of a color value and an alpha value includes using a table. The color values in the table are chosen for an attractive visualization of the tissue examined. Corresponding tables may be self-defined using an user interface, and to some extent selected from tables designed for medical applications and made available in galleries (Transfer Function Galleries).

The first color value (rgb_{Classified}) is fed into the shading unit (Block 7: Shading Unit). In the shading unit, a second color value (rgb_{Shaded}) is determined with the aid of the gradient and the fed-in color value, which takes into account the light incidence in the direction of view (Act 29). In one embodiment, a mixing unit (Block 8: Mixing Unit) may mix the first color value (rgb_{Classified}) and the second color value (rgb_{Shaded}), the mixing being weighted using the magnitude of the gradient (Approximate Gradient Magnitude). The mixing unit may produce a new color value (rgb_{mixed}), in which the influence of gradients with small magnitudes has been reduced with a view to noise suppression (Act 30).

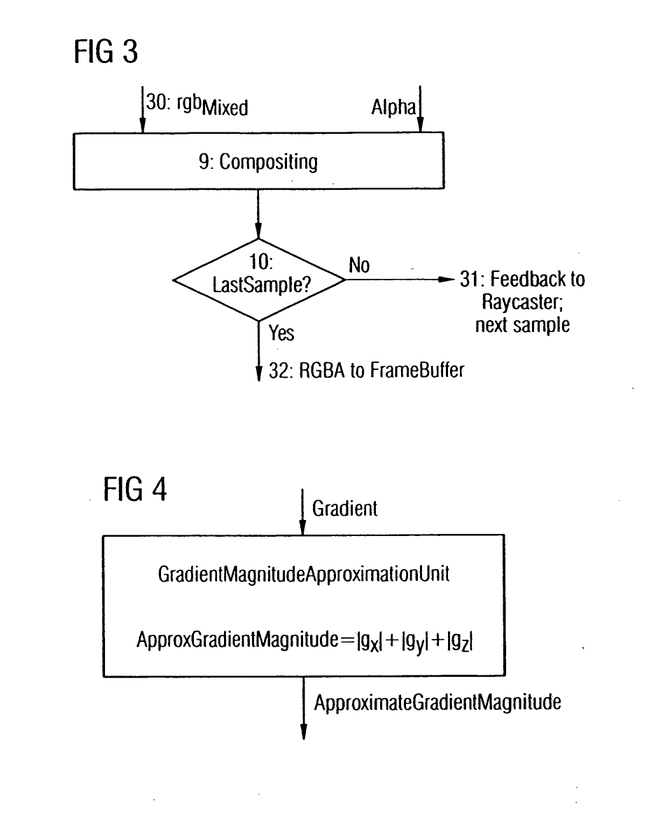

In one embodiment, as shown in FIG. 3, the mixed color value (rgb_{mixed}) and the alpha value (Alpha) obtained from the classification unit may be input into a combining unit (Block 9: Compositing), where color values and alpha values are put together to form pixels. This is repeated (Act 31: Feedback to Raycaster) until the entire light ray has been run through (Block 10: Decision Interrogation: Decision whether loop has been fully run through). The values for a ray that are fully combined to form a pixel of the two-dimensional picture may be stored for the image generation on a representation surface (Act 32: RGBA to FrameBuffer).

FIG. 4 shows an extract from a unit for estimating the gradient magnitude (Block 5: Gradient Magnitude Estimation Unit), in which an estimate of the magnitude is produced from the gradient components. The magnitudes of the three spatial components of the gradient are summated. This procedure delivers a result which may not possess the accuracy of the precise formula (square root of the sum of the squares of the components) but is adequate and is preferable due to the smaller effort in view of the large quantity of voxels and the large number of repetitions of the estimation of the gradient magnitude.

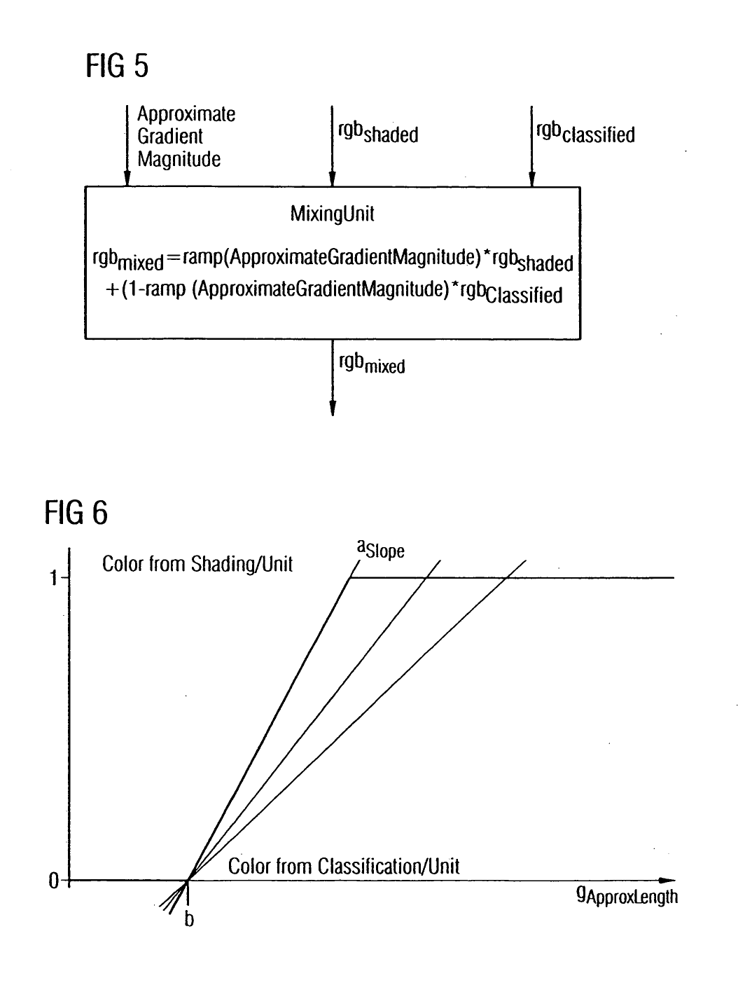

FIG. 5 shows a mixing unit (Block 8: Mixing unit) in which the mixed color value (rgb_{mixed}) is ascertained as a weighted average from the second color value (rgb_{Shaded}) and the first color value (rgb_{Classified}). A ramp function may be used depending on the magnitude of the gradient. The ramp function is shown in FIG. 6. The ramp function may include a function that is equal to 0 for small values of the gradient magnitude g_{ApproxLength} and then increases in a linear manner to the value 1. The values b (e.g., the gradient magnitude at which the function>0 and the slope aₛₗₒₚₑ) may be chosen suitably such that the area in which the function increases from 0 to 1 corresponds to the area in which gradient calculation becomes reliable. In defining the two parameters b and aₛₗₒₚₑ, recourse may be made to empirical values for typical value ranges in which the calculated gradient is meaningful or not meaningful. The defined parameters b and aₛₗₒₚₑ then go into the mixing of the color values as shown in FIG. 5 (use of the ramp function ‘ramp’ for mixing the color values).

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A method for adjusting a color value assigned to a spatial point for a low-noise volume rendering of an object, the method comprising:
assigning a first color value to the spatial point, which color value has been assigned to a variable characterizing the body in accordance with the value ascertained for that spatial point,
assigning a second color value to the spatial point, which color value has been ascertained from the first color value using an illumination model,
determining a color value, which is adjusted for low-noise volume rendering, using a weighted average of the first color value and the second color value, and
performing the weighting with a weighting function, wherein the weighting function is dependent on a magnitude of a gradient ascertained as a measurement of the change in the variable characterizing the body with reference to the spatial point, and the weighting function increasing from a minimum weighting value for the second color value to a maximum weighting value for the second color value.

2. The method as claimed in 1, wherein the minimum weighting value is zero and the maximum weighting value is one.

3. The method as claimed in claim 1, wherein the weighting function increases monotonically or strictly monotonically.

4. The method as claimed in claim 1, wherein the weighting function is a ramp function.

5. The method as claimed claim 1, wherein the spatial point comprises a voxel of a grid laid through the body or lies on a light ray transmitted through the body in the process of a simulated ray casting.

6. The method as claimed in claim 1, wherein the magnitude of the gradient is estimated by the sum of magnitudes of the gradient.

7. A device for carrying out a simulated ray incidence in a body to be represented, the device comprising:
a gradient measurement unit that is operable to determine a measurement for a length of a gradient,
a classification unit that is operable to assign a first color value to a variable characterizing the body,
a shading unit that is operable to generate a second color value by adjustment of a second color value using an illumination model, and
a mixing unit that is operable to determine a weighted average of two color values, wherein
the mixing unit is operable to determine a weighted average of the first and the second color values.

8. The device as claimed in claim 7, wherein the variable is a quantitative variable.

9. he device as claimed in claim 7, wherein the shading unit is operatively connected to the mixing unit, such that the second color value may be transferred from the shading unit to the mixing unit.

10. The device as claimed in claim 7, wherein the gradient measurement unit is operatively connected to the mixing unit, such that the length of the gradient may be transferred from the gradient measurement unit to the mixing unit.

11. The device as claimed in claim 7, wherein classification unit is operatively connected to the mixing unit, such that the first color value may be transferred from the classification unit to the mixing unit.

12. The method as claimed in claim 2, wherein the weighting function increases monotonically or strictly monotonically.

13. The method as claimed in claim 2, wherein the weighting function is a ramp function.

14. The method as claimed claim 2, wherein the spatial point comprises a voxel of a grid laid through the body or lies on a light ray transmitted through the body in the process of a simulated ray casting.

15. The method as claimed in claim 2, wherein the magnitude of the gradient is estimated by the sum of magnitudes of the gradient.
